(19) United States
(12) Patent Application Publication
(10) Pub. No.: US 2009/0125601 A1
(43) Pub. Date: May 14, 2009

(54) Electronic Messaging Systems Having Time-Critical Messages

(75) Inventor: Carl Anthony Braam, Chapel Hill, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/939,856

(22) Filed: Nov. 14, 2007

(51) Int. Cl. G06F 15/16

(52) U.S. Cl. 709/207

(57) ABSTRACT

To encourage recipients of electronic messages to respond in a timely manner, certain messages can be designated as time-critical messages. Such messages are delivered with an allowable response time attribute. If the recipient responds to the message within the allowable response time, nothing happens. If the recipient fails to respond within the allowable response time, the functionality of the recipient's system is altered in a way that gives the recipient an incentive to respond. For example, the recipient's system may be inhibited from receiving any further messages until the recipient responds to the time-critical message. Embodiments are described for implementing time-critical messaging in e-mail, instant messaging and voicemail systems.

### BACKGROUND OF THE INVENTION

The present invention relates to electronic messaging systems and to more particularly to electronic messaging systems in which recipients of time critical messages are given strong encouragement to reply to those messages in a timely manner.

The existence of electronic messaging systems and the development of high-speed global networks over which electronic messages can be transmitted have fundamentally changed how business and personal life is conducted. E-mail users can compose and send extremely detailed messages that may be delivered to recipients around the world almost in real time. Instant messaging (IM) users can also compose and send impromptu messages that can pop up (appear) on the computer display screen of a recipient that is already logged into the IM system, also almost in real time. Almost anyone with access to a touch tone telephone can leave a voicemail message for another telephone user who has subscribed to a voicemail service.

With any of these types of systems, a sender can conveniently provide information to many recipients concurrently or request information from such recipients. At times, a sender may have an urgent or even critical need for the requested information. Unfortunately, a recipient of an electronic message may not always feel the same sense of urgency as the sender. If that happens, a recipient may choose to ignore the sender's message. There has been little a sender could do to encourage a recipient to respond to a message the sender considered time-critical.

There is a need for a mechanism that will strongly encourage recipients of time-critical electronic messages to reply to those messages in a timely manner.

### BRIEF SUMMARY OF THE INVENTION

The present invention may be implemented as a method of creating an incentive for a target system user to respond to a time-critical electronic message received from a source system user. The timing operation is initiated upon receipt of the time-critical electronic message at the target system. If the timing operation completes before a response to the time-critical electronic message is transmitted by the target system, the operation of the target system is changed. The operation changes will be such as to provide the target system user an incentive to respond to the time-critical electronic message.

The present invention may also be implemented as a computer program product for creating an incentive for a target system user to respond to a time-critical electronic message received from a source system user. The computer program product includes a computer usable medium embodying computer usable program code configured to initiate a timing operation upon receipt of a time-critical electronic message at the target system and code configured to change the operation of the target system if the timing operation completes before a response to the time-critical electronic message is transmitted by the target system.

The present invention may also be implemented as an electronic messaging target system for creating an incentive for a target system user to respond to a time-critical electronic message received at the system. The system includes a timing component that performs the timing operation upon receipt of a time-critical electronic message. The system also includes a system control component for changing the operation of the target system if the timing operation completes before a response to the time-critical electronic message is transmitted by the target system.

### BRIEF DESCRIPTION OF THE SEVERAL VIEWS OF THE DRAWINGS

FIG. 1 is a schematic illustration of a generalized network in which electronic messaging can be implemented.

FIG. 2 is a more detailed illustration of components of an e-mail electronic messaging system.

FIG. 3 is a more detailed illustration of components of an instant messaging electronic messaging system.

FIG. 4 is a more detailed illustration of components of a voicemail electronic messaging system.

FIG. 5 is a flow chart of operations that are performed at a target system to encourage a recipient of the time-critical message to respond to that message in a timely manner.

FIG. 6 is a flow chart of a generalized process for sending a time-critical message.

FIG. 7 is a flow chart of a process for sending time-critical message in a typical voicemail electronic messaging system.

FIG. 8 is an example of an e-mail message template that can be used in an implementation of the present invention.

FIG. 9 is a schematic illustration of components of a special-purpose hardware component that can be used in implementing the present invention.

FIG. 10 is a schematic illustration of the major components of a general purpose programmable computer system that can be used in implementing the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

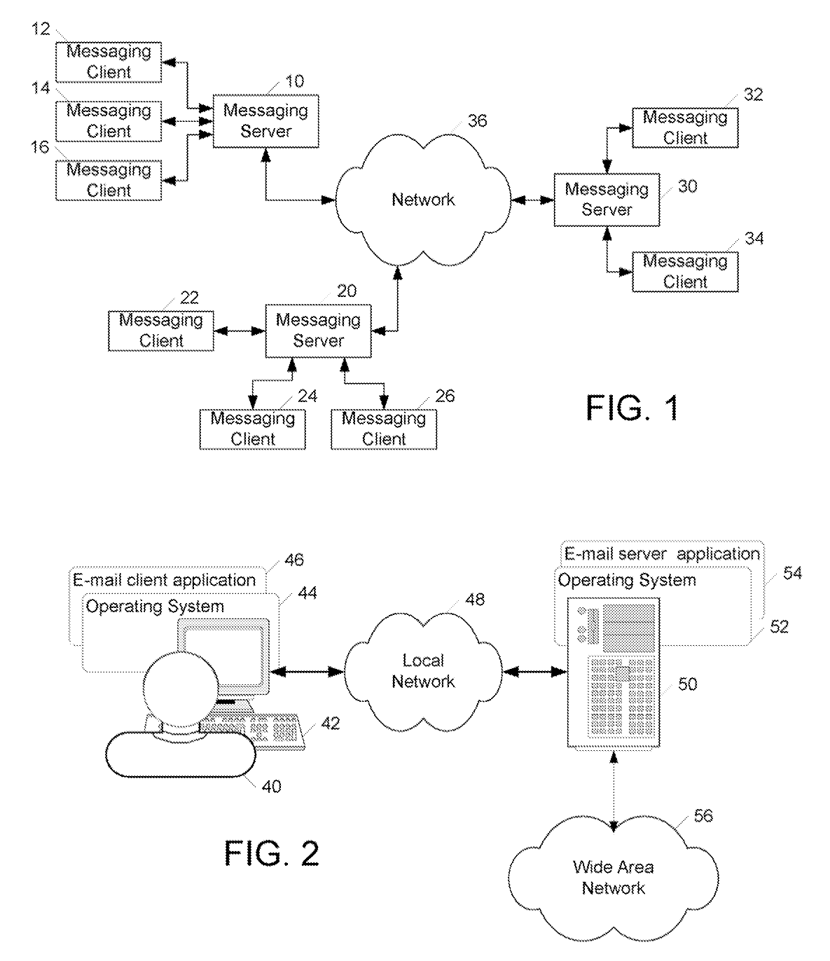

Electronic messaging systems are generally implemented using a client/server architecture in which many of the messaging functions are implemented in server devices, each of which supports multiple messaging client devices used by the human users of the electronic messaging systems. Referring to FIG. 1 for examples, a first messaging server 10 is shown with directly-connected messaging clients 12, 14, and 16, each of which is used by one or more human users. A second messaging server 20 is shown with three directly-connected messaging clients 22, 24, and 26 while third messaging server 30 is shown with two messaging clients 32 and 34. While only a few messaging clients are shown in the Figure for each of the messaging servers, this is for ease of illustration only. In practice, a messaging server ordinarily serves hundreds or perhaps thousands of messaging clients.

Typically, messaging servers communicate with one another through a network 36 which may be a local area network or a wide area network, such as a company intranet or a publicly accessible network, one example of which is the Internet. An electronic message created by a sender at a particular messaging client is typically relayed through its server and a network at least to the server that supports the intended recipient's client system. For certain types of electronic messaging systems, such as instant messaging systems, the electronic message may be forwarded all way to the messaging client where it pops up on a display included in the client system without a need for action by the user of the messaging client.

There can be subtle differences among different types of electronic messaging systems. FIG. 2 shows additional detail for a typical e-mail messaging system. An e-mail client typically includes a computer hardware device 42 that is most commonly a general purpose device controlled, at least in part, by operating system software 44 and running an e-mail client application program 46, all of which work together to provide e-mail functionality for human user 40. The e-mail client is supported by an e-mail server that includes a server hardware device 50 with its own operating system software 52 and an e-mail server application 54. The server and the client are normally connected through a local network 48 that can either be a wired network implementing a communications protocol such as an ethernet protocol or a wireless network implementing at least one standard wireless communication protocol.

The e-mail server device 50 is typically connected to a wide area network 56 that includes standard networking devices such as switches, routers, etc. that are used in used in routing e-mail messages between widely separated e-mail servers. The details of the communications protocols that are used to connect clients to servers or servers to servers are not important to an understanding of the invention and will not be discussed.

Although not shown in the Figure, the recipient of an e-mail message also uses an e-mail client and an e-mail server of the type discussed above. Typically, e-mails addressed to a recipient are held in storage at the server that supports the recipient's client until the recipient logs into the e-mail system and retrieves the stored messages.

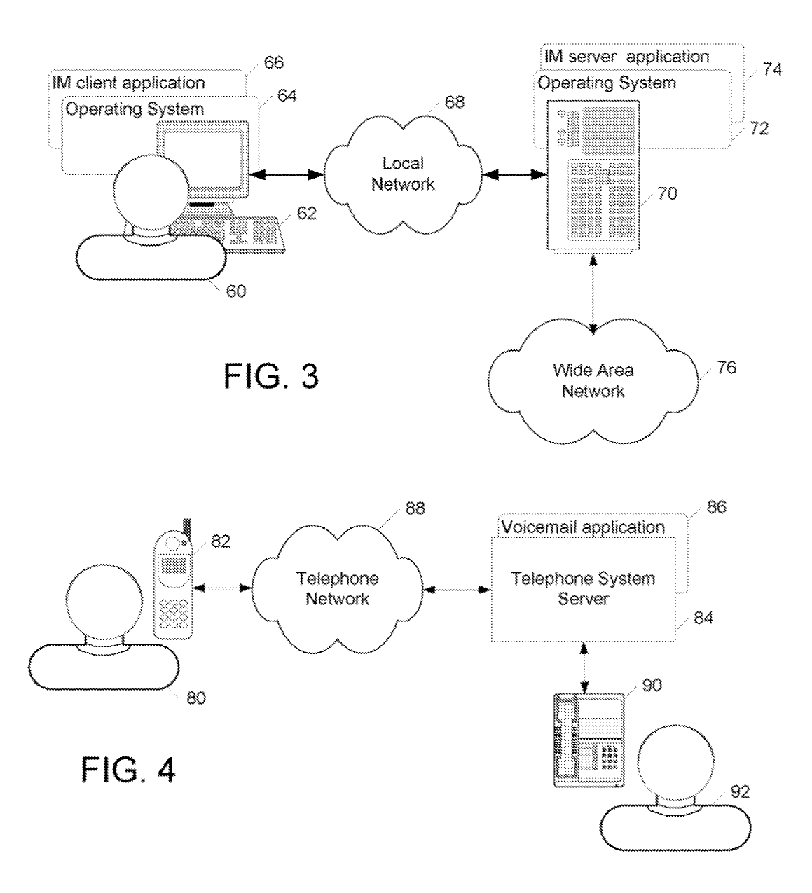

FIG. 3 shows some details of an instant messaging system, which is architecturally very similar to an e-mail system. Each human user 60 uses a client system that includes a hardware device 62, operating system software 64 and an instant messaging or IM client application 66. The IM client is supported by an IM server including a server hardware device 70 that is controlled by operating system software 72 and that executes an IM server application 74. The IM server interfaces with other IM servers (not shown) through a wide area network 76.

A comparison of FIGS. 2 and 3 show that e-mail systems and instant messaging systems are basically architecturally identical at the level illustrated. More commonly than not, the same client hardware device and server hardware device runs both e-mail software and IM software either as independent program applications or as integrated components of a single, multi-functional messaging application.

The architecture of a voicemail electronic messaging system can be different than the architectures of typical e-mail or IM messaging systems. For one thing, a human user 80 can interact with a remote voicemail system through a standard telephone, such as cell phone 82 shown in FIG. 4, without being a subscriber to a voicemail service. A standard cell phone may or may not include control logic that facilitates its use in a voicemail messaging system, but may instead interact with a remote voicemail messaging system through the use of key sequences entered through the cell phone keypad. The use of key sequences enables the user 80 to interact with a telephone system server 84 associated with a telephone 90 used by a second telephone user 92. The telephone system server 84, in addition to normal telephony functions, can execute a voicemail application 86 that stores a voicemail message provided by a remote caller, such as user 80, in the telephone system server 84 until retrieved by user 92. Thus, an originating user 80 does not necessarily have to be supported by his or her own voicemail server in order to make use of a remote voicemail server associated with a recipient.

However, it is likely that both senders and recipients of voicemail messages in systems implementing the present invention will have a common employer that controls voice mail servers used by both senders and recipients.

In basic terms, the present invention allows the sender of an electronic message to provide incentive for a recipient of that message to respond in a timely manner by (1) designating the electronic message as a time-critical message, and (2) establishing a time period within which the recipient must respond to the time-critical message (i.e., an allowable response time) before the functionality of the recipient's messaging system is affected. If the recipient fails to respond to the time-critical message within the allowable response time, for example, the recipient messaging system may be prevented from receiving other electronic messages until the recipient transmits a response to his or her messaging server. An alternative, but more draconian, functionality change might be to disable the recipient's messaging system from performing any function other than preparing and transmitting a response to the time-critical message.

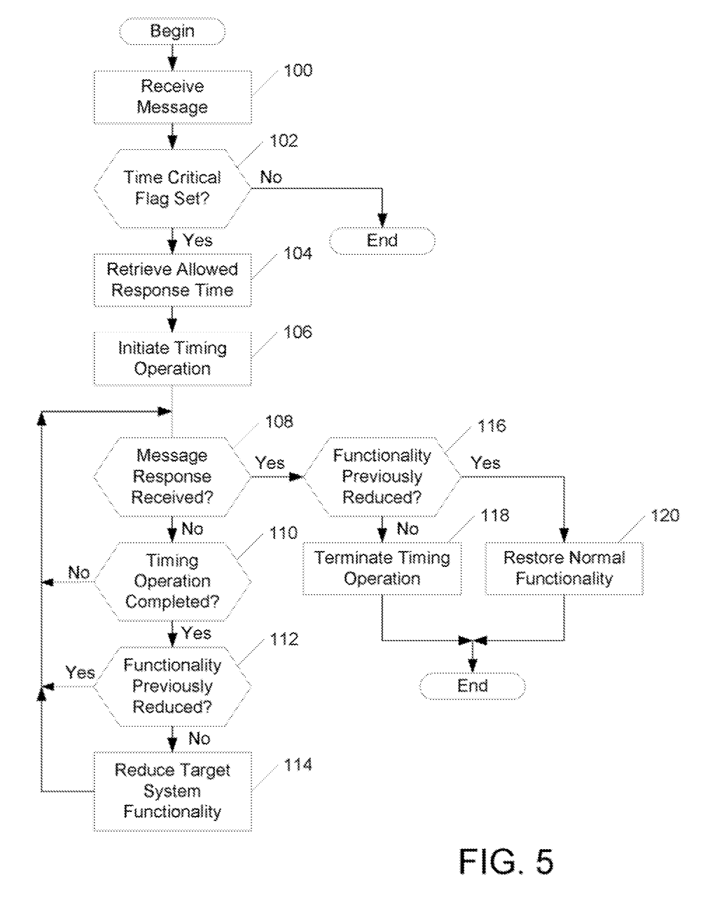

FIG. 5 is a flow chart of a generalized process for receiving and processing time-critical messages at an electronic messaging server supporting a recipient/user. Because the operation of the present invention can involve changing the functionality of a recipient messaging system, the process is typically performed in the messaging system server that supports the recipient messaging client.

The process begins with the receipt of an incoming electronic message in an operation 100. The message is analyzed in an operation 102 to determine whether a “time-critical” flag is set in the message. If the operation 102 indicates a time critical flag is not set (that is, that the received message is an ordinary electronic message not indicated as requiring a timely reply), the time-critical message process is terminated without further action and normal electronic message processing resumes. If, however, the time-critical flag is found to be set, the message is analyzed or parsed in an operation 104 to retrieve an “allowed response time” value included within the message. A timing operation 106 is initiated, preferably by initializing a start count for countdown timer. The start count value is dependent upon the retrieved allowed response time. Once the countdown counter is initialized, it is triggered to start the countdown towards zero.

Once the timing operation is initiated, the server begins to analyze messages (operation 108) received from the target system to determine whether one of those messages is a response to the time-critical message. If no response to the time-critical message is identified, it is then determined (operation 110) whether the timing operation has completed; e.g., the countdown timer has counted down to zero. If the timing operation is not completed, program control loops back to operation 108 to continue monitoring of messages received from the target system.

Once the initiated timing operation is determined (in operation 110) to have been completed, the server must then check (operation 112) whether changes in functionality of the target system have already been made in a previous iteration of the process. On the first iteration of the process, however, operation 112 will always find that the functionality has not been reduced, leading to an operation 114 that brings about the functionality changes. As noted earlier, reductions in target system functionality can include such changes as inhibiting receipt of new electronic messages at the target system or preventing the target system from performing any messaging function other than the preparation and transmission of a response to the time-critical message. Clearly, such changes in messaging functionality establish incentive for the recipient of the time critical message to respond to that message.

If operation 112 indicates the functionality of the target system is already been changed or if the functionality is reduced in operation 114, program control loops back to the input of operation 108 to continue monitoring messages received from the target system client in order to determine whether any of those messages is a response to the time-critical message. The program loop consisting of operations 108, 110, 112 and 114 will repeat until operation 108 detects a response to the time-critical message.

Since a detected response may occur either before or after the allowable response time has been exceeded, the state of the target system must be established. An operation 116 is performed to determine whether the functionality of the target system has already been reduced. If the functionality of the target system has not already been reduced, meaning the allowable response time has not been exceeded, the timing operation is terminated (operation 118) and time-critical processing is terminated without the functionality of the target system ever having been affected. If the operation 116 shows that the functionality of the target system was reduced before a response to the time-critical message was generated in the target system, normal target system functionality is restored (operation 120) at the target system and time-critical message processing is terminated.

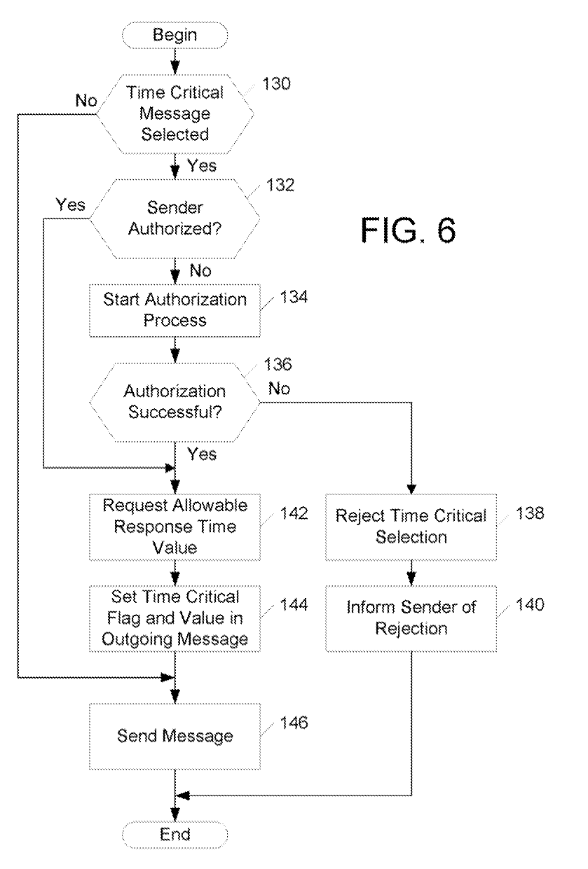

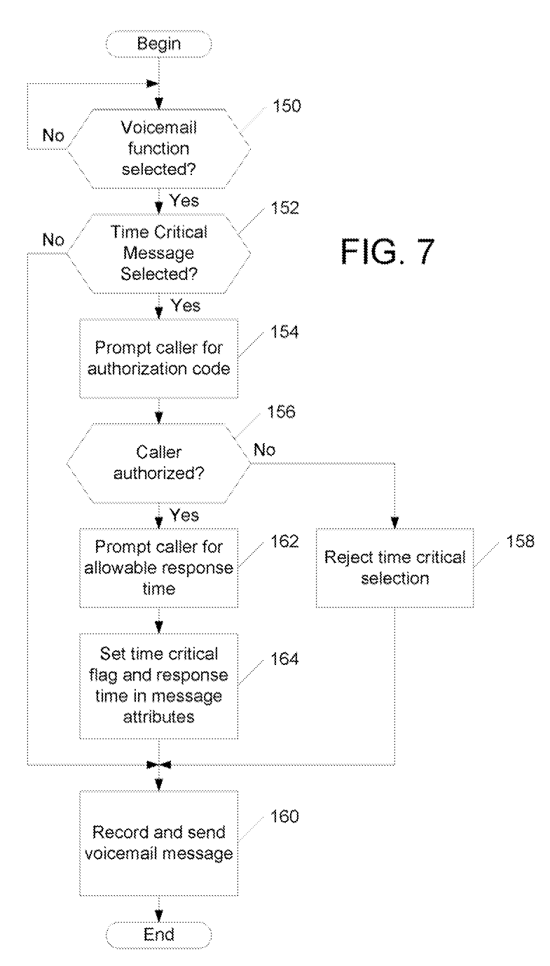

The flowchart discussed above depicts time-critical message processing from the recipient's point of view. The flowchart shown in FIG. 6 depicts time-critical message processing from the sender's point of view.

Since the receipt of time-critical messages can have a significant impact on recipients of those messages, the sender-side processing of a time-critical message preferably requires an overt act by a sender to designate a message as being time-critical before the message is transmitted to the recipient. An operation 130 is used to determine whether the sender has designated the message as being time-critical. If the message is not found to have been designated as time-critical, any time-critical processing steps are bypassed and the message is sent without any time-critical designation in an operation 146.

If, however, operation 130 shows that the message has been designated as time-critical, a determination must then be made as to whether the sender has the authority to send time-critical messages. Not every system user who is capable of sending an electronic message should be authorized to designate a message as time-critical. Generally speaking, the ability to designate messages as time critical is best limited to executives and managers who have demonstrated critical need for timely responses from message recipients.

The authorization process can take different forms but begins with an operation 132 that determines whether the sender has already been found to be authorized. Before actually using an e-mail or instant messaging system, a user must have already completed a login process that requires that he or she provides a user ID and password. The login process authenticates the user; that is, provides some assurance that the user is who he or she purports to be. Once a user is authenticated, a stored profile associated with a user may be retrieved to determine the authority of the user. If the retrieved profile indicates the authenticated user has the authority to designate messages as being time-critical, certain steps in the process can be bypassed. However, if operation 132 fails to establish that the sender has already been authorized to designate messages as time-critical, a separate authorization process can be started in operation 134.

No particular authorization process is required for an implementation of the present invention. A user may be prompted to enter a password specific to the time-critical message process. Alternatively, a user may be provided a scannable card that establishes the authority of the cardholder to designate messages as time-critical.

A determination 136 is made to determine whether the sender is authorized to designate messages as time critical. If the authorization process fails, the designation of the message as time-critical is rejected in an operation 138 and the sender is informed of the rejection in an operation 140. Time-critical message processing is ended at this point. If, however, the determination 136 shows that the sender is authorized to designate messages as time-critical, the sender is prompted (operation 142) to provide the allowable response time value; that is, the time permitted the recipient of the message to provide a response without the functionality of the recipient's system being affected. While a default response time value might be suggested to the sender, it is probably better to require that the sender to explicitly establish the response time value each time time-critical messages are to be sent. Once the allowable response time is established, a time-critical flag is set (operation 144) in the message control information along with the allowable response time and the message is sent in an operation 146.

Since a caller who wants to leave a message using a voicemail system does not ordinarily have to be logged in to the system before initiating the process of leaving a message, a different sender process may be employed for such systems. The process begins when the caller initiates a voicemail process in an operation 150, typically by selecting a particular key or set of keys on the caller's telephone when prompted by the voicemail system. Once the voicemail process is initiated, the caller may designate (operation 152) the voicemail as being time-critical. If the caller fails to designate the voicemail is being time-critical, further time-critical processing is skipped and the message is recorded and sent in an operation 160.

If the caller does designate the voicemail message as being time-critical in operation 152, a determination must still be made as to whether the caller is actually authorized to make that designation. The caller is prompted (operation 154) to enter an authorization code or password in the form of a particular key sequence associated with the particular caller. If the password is not found to be valid (operation 156), the attempt to designate the voicemail message is time-critical is rejected in operation 158 and the caller is advised of the rejection. In at least in one embodiment of the invention, the voicemail process is not explicitly terminated even if the caller's attempt to designate the message is time-critical is rejected because it is assumed that a caller who did not wish to leave any message other than a time-critical message can implicitly terminate the process simply by hanging up the telephone. Instead, the caller is given the option of recording and sending an ordinary (not time-critical) voice mail message in operation 160.

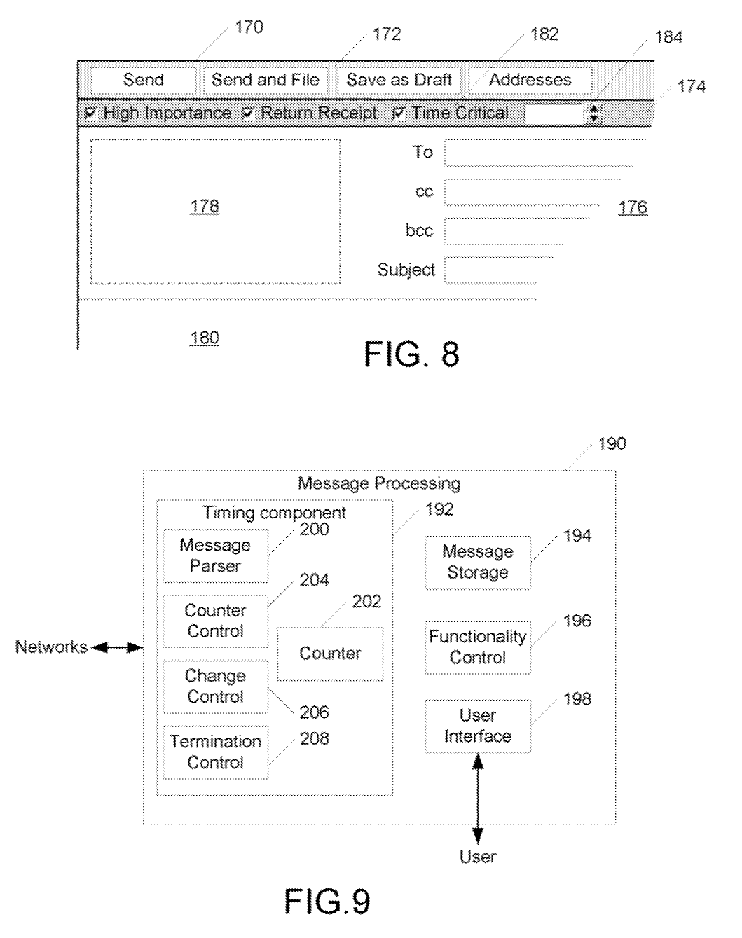

FIG. 8 illustrates how the process of designating a time-critical message can be handled in an e-mail template available to the sender. The drawing shows only part of the complete e-mail template, including a function bar 170 including typical user-selectable functions relating to tasks performed in composing and sending any e-mail message. Different e-mail clients will portray user-selectable functions in different ways or under different names. The template also includes a message attribute bar 174 (which is discussed in more detail below), a header area 178 that typically includes the sender's e-mail address and some sort of decorative graphic, and addressee/subject area 176, and a body area 180 in which the actual message content is entered.

To adapt such a template for use in a process for sending time-critical messages, an additional Time Critical check box 182 is added to the message attribute bar 174 along with a dialog box 184 into which an allowable response time value can be entered, either directly or by the use of spinner controls as shown in the Figure. In ordinary use, selection of the Time Critical check box 182 by a sender will trigger the process described above with reference to FIG. 6.

Situations will arise where a recipient of a time-critical message cannot possibly respond to the message within the allowable response time established in the message. For example, the recipient may be out of the office when the e-mail is received at the addressee e-mail server. If the addressee has set up an “Out of Office” message, as is often suggested by employer e-mail guidelines, the Out of Office message itself is a response that will terminate any time-critical timing operation initiated when the time-critical message was received at the addressee's e-mail server. In some e-mail systems, a single “Out of Office” status message may be returned to a particular sender even where the sender sends multiple messages to the recipient. In such systems, it may be preferable for the first “Out of Office” message returned by a particular recipient to any sender to inhibit use of the time-critical process until the recipient's “Out of Office” status is terminated.

In instant messaging systems, the instant messaging addressee or target must be logged onto the target instant messaging server in order for the instant message to be received in the first place. If a time-critical message is not received because the addressee is not logged on, no timing operation can be initiated. Some instant messaging systems give the sender an option of sending an e-mail message to a user who is not logged on to an instant messaging server. Where a time-critical e-mail message is sent as a substitute for an instant message, that e-mail message will be processed just like any other time-critical e-mail message.

In some instant messaging systems, a user can leave status messages that indicate the user is logged onto the instant messaging system but does not wish to or cannot receive instant messages for the present. For example, a user may set up a Do Not Disturb status message, the meaning of which is intuitively clear. While a system implementer could choose to implement an instant messaging system in which time-critical message designations are given priority over Do Not Disturb status messages, it would perhaps be preferable to inhibit any time-critical instant messages where an addressee had previously established a Do Not Disturb status.

In voicemail systems, users can ordinarily leave recorded messages providing details as to why they are unavailable to answer a telephone. However, it is well known that callers often don't listen to such messages before taking steps to record a voicemail message. To deal with impatient callers, it may be preferable to give voicemail users an option of blocking time critical messages whenever the target user's phone is not answered.

It may be preferable in some situations to implement the invention as a dedicated message processing system 190 of the type shown in FIG. 9. The major components of a dedicated message processing system will include a timing component 192, a message storage component 194, a functionality control component 196 for changing the functionality of a recipient's messaging system when necessary, and a user interface 198.

The timing component 192 will include at least a message parser 200 for parsing an incoming e-mail message to determine, among other things, whether the message is designated as time-critical and, if so, the magnitude of the allowable response time value included in the message. The timing component 192 also includes counter 202 for establishing the allowable response time, counter control logic tool for controlling the counter operation, change control logic 206 for establishing a counter start time and termination control logic 208 for terminating the counting process without changing the functionality of the target system when a response is transmitted by the target system before the timing operation completes.

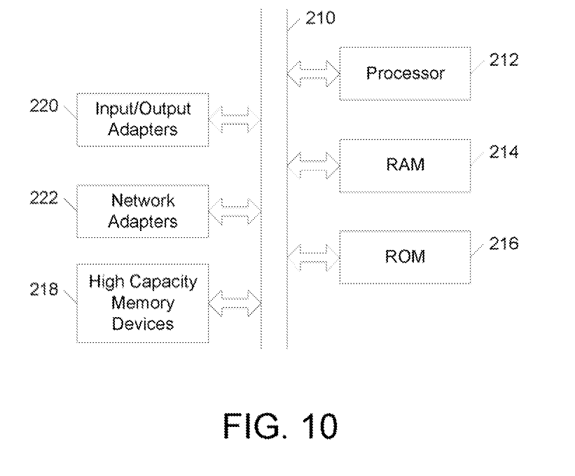

Alternatively, the invention may be implemented by programming a general purpose computer system having a functional infrastructure of the type illustrated in FIG. 10. The infrastructure includes a system bus 210 that carries information and data among a plurality of hardware subsystems including a processor 212 used to execute program instructions received from computer applications running on the hardware. The infrastructure also includes random access memory (RAM) 214 that provides temporary storage for program instructions and data during execution of computer applications and are read only memory (ROM) 216 often used to store program instructions required for proper operation of the device itself, as opposed to execution of computer applications. Long-term storage of programs and data is provided by high-capacity memory devices 218, such as magnetic hard drives or optical CD or DVD drives.

In a typical computer system, a considerable number of input/output devices are connected to the system bus 210 through input/output adapters 220. Commonly used input/output devices include monitors, keyboards, pointing devices and printers. Increasingly, high capacity memory devices are being connected to the system through what might be described as general-purpose input/output adapters, such as USB or FireWire adapters. Finally, the system includes one or more network adapters 222 that are used to connect the system to other computer systems through intervening computer networks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims. For example, disabling functionality in a recipient system will impact both the recipient and other users who later attempt to send electronic messages to the “disabled” recipient. To reduce the impact on other users, notices may be returned to those users to inform them the recipient system temporarily cannot receive electronic messages. At the same time, the undelivered messages may be queued for delivery to the recipient once normal recipient system functionality is restored. This and other variations and modifications fall within the scope of the invention defined in the appended claims.

What is claimed is:

1. A method of creating an incentive for a user of a target system to respond to a time-critical electronic message received from a user of a source system comprising:
initiating a timing operation upon receipt of the time-critical electronic message at the target system; and
changing functionality of the target system if the timing operation completes before a response to the time-critical electronic message is transmitted by the target system.

2. A method according to claim 1 wherein initiating a timing operation further comprises:
extracting an allowable response time value from the received time-critical electronic message; and
changing the duration of the timing operation in accordance with the extracted allowable response time.

3. A method according to claim 2 wherein initiating a timing operation further comprises:
setting a start count for a countdown timer at a value dependent upon the extracted allowable response time value; and
triggering the countdown tinier to count from the start count towards zero.

4. A method according to claim 3 further comprising terminating the timing operation upon transmission of a response by the target system

5. A method according to claim 4 wherein changing functionality of the target system comprises disabling the reception of further electronic messages at the target system until a response to the time-critical electronic message is transmitted by the target system.

6. A method according to claim 4 wherein changing functionality of the target system comprises inhibiting any use of the target system other than to respond to the time-critical electronic message

7. A method according to claim 4 further comprising presenting the time-critical electronic message at the target system in a distinctive manner to alert the user of the target system to the time-critical message.

8. A computer program product for creating an incentive for a user of a target system to respond to a time-critical electronic message received from a user of a source system, said computer program product including a computer usable medium having computer usable program code embodied therewith, said computer usable program code comprising:
computer usable program code configured to initiate a timing operation upon receipt of the time-critical electronic message at the target system; and
computer usable program code configured to change functionality of the target system if the timing operation completes before a response to the time-critical electronic message is transmitted by the target system.

9. A computer program product according to claim 8 wherein said computer usable program code configured to initiate a timing operation upon receipt of the time-critical electronic message at the target system further comprises;
computer usable program code configured to extract an allowable response time value from the received time-critical electronic message; and
computer usable program code configured to change the duration of the timing operation in accordance with the extracted allowable response time value.

10. A computer program product according to claim 9 wherein said computer usable program code configured to initiate a timing operation upon receipt of the time-critical electronic message at the target system further comprises:
computer usable program code configured to have a start count for a countdown timer in the value dependent upon the extracted allowable response time; and
computer usable program code configured to trigger the countdown timer to count from the start count towards zero.

11. A computer program product according to claim 10 further comprising computer usable program code configured to terminate the timing operation upon transmission of a response by the target system.

12. A computer program product according to claim 11 wherein said computer usable program code configured to change functionality of the target system if the timing operation completes before a response to the time-critical electronic message is transmitted by the target system further comprises computer usable program code configured to disable the reception of further electronic messages at the target system until a response to the time-critical electronic message is transmitted by the target system.

13. A computer program product according to claim 11 wherein said computer usable program code configured to change functionality of the target system if the timing operation completes before a response to the time-critical electronic message is transmitted by the target system further comprises computer usable program code configured to inhibit any use of the target system other than to respond to the time-critical electronic message.

14. A computer program product according to claim 12 further comprising computer usable program code configured to present the time-critical electronic message at the target system in a distinctive manner to alert the user of the target system to the time-critical electronic message.

15. A electronic messaging system for creating an incentive for a user of a target system to respond to a time-critical electronic message received from a user of a source system comprising:
a timing component for performing a timing operation upon receipt of the time-critical electronic message at the target system; and
a system control component for changing functionality of the target system if the timing operation completes before a response to the time-critical electronic message is transmitted by the target system.

16. A messaging system according to claim 15 wherein said timing component further comprises:
a message parser for extracting an allowable response time value from the received time-critical electronic message; and
a timer change control component for changing the duration of the timing operation in accordance with the extracted allowable response time value.

17. A messaging system according to claim 16 wherein said timing component further comprises a counter control component for setting a start count for a countdown timer at a value dependent upon the extracted allowable response time value and for triggering the countdown timer to begin counting from the start count towards zero.

18. A messaging system according to claim 17 wherein said counter control component further comprises a termination component for terminating a timing operation upon transmission of a response by the target system.

19. A messaging system according to claim 18 wherein said system control component further comprises a component for disabling the reception of further messages at the target system until a response to the time-critical electronic message is transmitted by the target system.

20. A messaging system according to claim 18 wherein said system control component further comprises a component for inhibiting any use of the target system other than to respond to the time-critical electronic message.
